(19) United States
(12) Patent Application Publication
(10) Pub. No.: US 2016/0253903 A1
(43) Pub. Date: Sep. 1, 2016

(54) EMERGENCY VEHICLE ALERT SYSTEM AND METHOD

(71) Applicant: Robert Wilk, Holly, MI (US)

(72) Inventor: Robert Wilk, Holly, MI (US)

(21) Appl. No.: 14/632,619

(22) Filed: Feb. 26, 2015

(51) Int. Cl. G08G 1/0965; G08G 1/087

(52) U.S. Cl. CPC G08G 1/0965; G08G 1/087

(57) ABSTRACT

An emergency vehicle alert system and method that uses a low-power radio frequency transmitter connected to an emergency vehicle, and a radio with multiple tuners connected to a passenger or light vehicle. Most currently produced passenger or light vehicles use radios with multiple tuners. One or more of those tuners can be re-purposed, periodically, to scan an emergency frequency for an emergency message. Upon receiving an emergency message that exceeds a pre-defined threshold, the system and method would switch the audio output of the passenger or light vehicle to broadcast the emergency message.

### FIELD OF INVENTION

This invention relates, inter alia, to the class of communication: electrical; and the sub-class condition responsive indicating system. Specifically, this invention relates to an emergency vehicle alert system for passenger cars and light trucks, that notifies the driver of an approaching emergency vehicle.

### BACKGROUND OF INVENTION

Currently, the U.S. car parc (total number of registered vehicles in service) exceeds 225,000,000 and the worldwide car parc exceeds an estimated 800,000,000 vehicles. Close to 16,000,000 new light vehicles will be sold in 2015 in North America, and close to 96,000,000 worldwide. By 2020, it is estimated that U.S. sales will exceed 18,000,000, and worldwide sales will exceed 115,000,000. A substantial portion of the explosive growth in the worldwide new vehicle market is due to the increasing demand for vehicles in China.

At the same time, the driver is becoming much more insulated from the surrounding environment. First, the interior of the most light vehicles have become much quieter and more insulated from the external environment. Measures of NVH (noice, vibration, and harshness) bear this out. Second, many cars have powerful entertainment and infortainment systems that distract the driver, and further remove the driver from a sensory connection with the external environment. Such entertainment and infotainment systems may include, inter alia, analog radio; digital radio; a radio data system (“RDS”) that displays small amounts of formatted text on a display; satellite radio; powerful audio amplifiers, multiple loudspeakers and sub-woofers; a dedicated music hard-drive; streaming Blue-Tooth® capabilities; hands-free telephone; rear-seat entertainment systems, including video; navigation using a map on a display; email service enabled through speech-to-text and text-to-speech engines; and voice recognition software. Most vehicles are sound insulated from the outside, and have a variety of enhanced audio in the cabin. As a result, most drivers are totally dissociated from their external auditory surroundings while driving.

The explosion in electronics has been driven by a proliferation of digital electronics and software. A generation ago, radio tuners used a large number of electronic components on a printed circuit board. Now, radio tuners are realized using a single chipset. Modern automotive radios mostly have multiple tuners, capable of rapidly tuning to different frequencies. Typical architectures involve having one tuner delivering audio information, while one or more, additional tuners work in the background, insuring that the radio is tuned onto the absolute best frequency. By using multiple tuners, current technology allows for much higher off-center rejection, reducing noise, while it improves reception. Multiple tuner methods are largely realized with software, rather than hardware. The radio tuner software, in many cases, can be updated through well-defined means at a local dealership. In this way, the radio, as well as the rest of the entertainment/infotainment system can be updated to insure that it has maximum functionality and reliability. A multi-tuner radio is the one system constant in modern automobile infotainment and entertainment systems. Driver isolation and driver distraction are exacerbated by current vehicle design.

It is estimated that there are about 10,000 collisions per year, involving emergency vehicles while in emergency-response mode, leading to anywhere between 50-100 fatalities. Most emergency vehicles collisions are the results of distracted or unaware drivers. In addition to collisions between emergency vehicles and non-emergency vehicles, there is a phenomenon known as the “Wake Effect,” in which an emergency vehicle passing with its lights and sirens activated substantially increases the chances of collisions by two or more vehicles, as the emergency vehicle passes. The Wake Effect is attributed to a variation in awareness between involved drivers.

Emergency response by public safety vehicles is fraught with danger. The situation is exacerbated by distracted and unaware drivers. The architecture of electronic infotainment and entertainments systems in cars and light trucks contributes to the problem. No suitable solution has been found, so far, due to the greatly varied electronics architectures from vehicle-to-vehicles, and the limitations of external sirens and flashing lights. What is needed is a system that is easily adaptable to a substantial portion of current and future vehicles, without great cost, that will alert drivers to approaching emergency vehicles. Such a system must overcome the isolation from external auditory sensation inherent in most new light vehicles; and must provide reasonable notification for both distracted and unaware drivers, regardless of the architecture of their entertainment/infotainment system.

### REVIEW OF THE PRIOR ART

The prior art for emergency alert systems is disappointing. Although emergency vehicle collisions and Wake Effect collisions are significant, both in terms of loss of life and loss of money, there is no suitable solution on the market or in the prior art. The current prior art teaches only devices that require specific hardware be installed into a vehicle. This solution adds substantial expense, and makes retro-fitting a large number of vehicles impractical.

For example, U.S. Pat. No. 6,339,382, by named inventors Arbinger, et al., issued Jan. 15, 2002, is entitled, “Emergency vehicle alert system,” (“Arbinger '382”). Arbinger '382 teaches a system that has an emergency vehicle unit, a motor vehicle unit, and a display containing at least four (4) indicator lights. The motor vehicle unit includes an emergency GPS antennae, an emergency GPS receiver, an emergency RF antennae, and an emergency RF receiver. The emergency vehicle would transmit the GPS coordinates of the emergency vehicle using RF, and the passenger vehicle would receive the GPS coordinates using an emergency RF receiver. This system requires, at least, an emergency GPS receiver, an emergency GPS antennae, an emergency RF receiver, an emergency RF antennae, and a plurality of indicator bulbs. The system cannot be reasonably retrofitted to existing vehicles in the car parc. Additionally, the system cannot be implemented in any vehicle that is not GPS enabled (a majority of vehicles, even in the United States).

U.S. Pat. No. 7,099,774, by named inventors King, et al., issued Aug. 29, 2006, is entitled, “GPS based vehicle warning and location system,” (“King '774”). King '774 teaches the use of the same emergency RF receiver, emergency RF antennae as used in Arbinger '382. King '774 still requires the passenger vehicle to have a GPS unit. King '774 still requires that the GPS receiver and antennae be a dedicated unit (it is not dual use). King '774 teaches an improvement as to the location of the emergency vehicle.

U.S. Pat. No. 4,403,208, by named inventors Hodgson, et al., issued Sep. 6, 1983, is entitled, “Warning-signal-producing system for a motor vehicle responsive to a vehicle-presence-indicating radio wave signal emitted by another vehicle and indicative of its presence,” (“Hodgson '208”). Hodgson '208 teaches a very specific and detailed system using RF to warn vehicles of an approaching emergency vehicle. The emergency vehicle would have a transmitter to transmit a warning signal. The passenger vehicle would have a RF receiver to receive the warning signal. The strength of the warning signal would switch the radio to an emergency message when the warning signal exceeded a pre-defined level, using a coupling circuit comprised of a limiter and gate. The passenger vehicle would have to have a switch, an emergency signal RF receiver, and a coupling circuit, in addition to any normal entertainment radio.

U.S. Pat. No. 4,794,394, by named inventor Halstead, issued Dec. 27, 1988, is entitled Emergency vehicle proximity warning system (“Halstead '394”). Halstead '394 teaches a system that includes a low power transmitter subsystem carried on board an emergency vehicle and a special purpose receiver subsystem carried on board a passenger vehicle. The transmitter issues a continuous stream of equally timed-spaced pulses. The receiver subsystem has a logic output that controls a relay coil and relays, interrupting the entertainment radio and providing an emergency alert. Clearly, Halstead '394 adds additional cost, in that it requires a special purpose receiver and relay circuit to a standard radio system.

U.S. Pat. No. 5,889,475, by named inventors Klosinski, et. al., issued Mar. 30, 1999, is entitled, “Warning system for emergency vehicles,” (“Klosinski '475”). Klosinski '475 teaches an all-encompassing system that tries to change traffic lights, locate emergency vehicles, and notify passenger vehicles. Klosinski '475 teaches a system comprising: (a) an emergency vehicle transmitter; (b) a passenger vehicle receiver; (c) audio and video indicators; (d) a system for activating and deactivating the indicators depending on the signal strength sensed by the passenger vehicle receiver; (e) an amplitude modulator, that increases the amplitude of the transmitted signal with the speed of the emergency vehicle; (f) a positioning device (GPS); (g) a navigation means for determining the quickest route to an emergency scene; (h) a means for switching traffic lights green for the emergency vehicle. Obviously, such a complex system would add additional cost to a passenger vehicle; and it would be almost impossible to retrofit to existing vehicles.

U.S. Pat. No. 6,252,519, by named inventor McKenna, issued Jun. 6, 2001, is entitled, “Emergency vehicle signaling system,” (“McKenna '519”). McKenna '519 teaches a system that has an RF transmitter in the emergency vehicle, and an RF receiver in the passenger vehicle. McKenna '519 adds to the prior art by teaching the use of a conical emergency signal and a rearward facing indicator light.

Other solutions have been attempted. The prior art teaches several systems using photdetectors to detect the approach of emergency vehicles: U.S. Pat. Nos. 5,495,243; 7,446,674; and 7,538,687. The prior art teaches systems that selectively broadcast an emergency warning to passenger vehicles based off of the location of the passenger vehicle and the approaching emergency vehicle using GPS and/or telematics: U.S. Pat. Nos. 7,113,107; 7,212,134; 8,258,979; and 7,508,320.

The additional prior art in the area is merely cumulative to the themes described above. The prior art adds substantial and expensive hardware to the passenger vehicle. The prior art is difficult to retrofit to the existing car parc. The prior art is too complex for the vehicle industry to find a single, compelling answer, to serve as a standard. As a result, there are almost no widely accessible products on the market for providing notification to approaching emergency vehicles. What the market needs is a low-cost solution that is easily implemented and easily retrofitted to a substantial portion of the existing car parc.

### SUMMARY OF THE INVENTION

This Summary of Invention illustrates the present invention by providing a description of an embodiment. The Summary of Invention is not intended to limit, in any way, the scope of the present invention. The present invention improves and expands upon the prior art, by creating an inexpensive system that seamlessly integrates with a variety of past and present radios used in vehicle entertainment/infotainment infrastructures. The present invention has six components: a dedicated, low-power transmitter mounted on an emergency vehicle to transmit an emergency message; a radio frequency tuner in a passenger vehicle or light vehicle; a software method employed by a radio frequency tuner to detect an emergency message that exceeds a pre-defined threshold level, indicating that the emergency message is in the near proximity of the passenger vehicle or light vehicle; a software method to create a service interrupt to the entertainment/infotainment system upon detection of the presence of the emergency message; and a switching means to switch the audio output of the entertainment/infotainment system to the tuner broadcasting the emergency message.

As a preliminary matter, the transmission of radio frequency energy is regulated by the Federal Government. For a system to be practical, there needs to either be existing authority to implement such a system, or the reasonable likelihood that such a system can be implemented without inordinate financial burden. In the United States, the Federal Communication Commission (“FCC”) promulgates rules that govern radio transmitters. Part 15 of the FCC regulations govern low-power, unlicensed transmitters (typically 10 W or less). Part 15 restricts the effective range of a low-power, unlicensed transmitter to 200 ft (61 meters). This might not be a large enough broadcast area for the mobile emergency transmitter to be effective.

Luckily, the FCC also promulgates rules for use of licensed Low-Power FM transmitters for mobile and public safety applications under authority provided by one or more of the following acts of Congress: Radio Broadcasting Preservation Act of 2000; Local Community Radio Act of 2005; Local Community Radio Act of 2007; Local Community Radio Act of 2009; and Local Community Radio Act of 2010. In the U.S. most Low-Power FM transmitters are under 91.9 MHz. Currently, only two small Low-Power FM fixed installations exist, in the entire United States, which use 87.9 MHz center frequency. The present invention should fit into one or more of the already existing carve-outs for low-powered FM transmission provided by the FCC.

The low-powered FM transmitter would be mounted into an emergency vehicle, preferably the front. The low-powered FM transmitter would be fed a transmission message. The transmission message could be a simple, digital loop recording such as, “Emergency vehicle approaching.” The present invention could also be integrated with a GPS/navigation system for the emergency vehicle, so that the transmission message could include location information such as, “Emergency vehicle heading westbound on Ford Road approaching Interstate 275 entrance ramp.”

The maximum output of the low-powered FM transmitter would be calibrated to a speed of 100 kilometers per hour or kph (62 miles per hour or mph). The low-powered FM transmitter would have an average speed proportional attenuator that would take the radiated power down to a maximum of 10 Watts when the vehicle's speed was 0 kph. In this way, the transmitter can transmit large distances, while the emergency vehicle is on a highway, for example up to 5 km or 3.2 miles. The transmitter can transmit a much smaller distance when the vehicle is stopped, for example 150 m or 500 ft.

The emergency transmission would be received by a background tuner in a multiple tuner FM radio. The background tuner in multiple tuner FM radios repeatedly scans different frequencies around a center-frequency, in order to maximize the signal strength of the FM radio. A software method would be added to periodically check the emergency frequency, for example 87.9 MHz. The check for emergency frequency could be performed every second, or every 5 or 10 seconds. In any event, the emergency frequency check is occurring much more slowly that the background tuner is typically scanning frequencies. As a result, the present invention would not appreciably impair performance of new or existing FM radios. Additionally, in modern infotainment systems, background tuners are active even when the infotainment system is not playing the FM radio. In this way, the background tuner can monitor an emergency frequency while the vehicle passengers are using, for example, a hard-drive music player, a hands-free telephone, or a navigation system.

When the background tuner detects an emergency transmission on the emergency frequency, a software method in the present invention would provide a system interrupt command, allowing the audio system input to be changed to the emergency transmission. In all cars build since about the year 2002, the entertainment/infotainment system is on a bus network, such as CAN or MOST. This is true of even moderately priced vehicles that only have radio. The bus system is used, for example, to attenuate the audio system for warning tones, and to give the audio system power up and power down commands, even in rudimentary systems. The bus network communicates with the entire entertainment/infotainment systems, and they operate on messages. One of these messages is a system interrupt, that allows the audio system to be re-purposed. In the present invention, reception of an emergency transmission by the background tuner would initiate a system interrupt. The system interrupt would be followed by a command to then switch the audio system to the emergency transmission, adjusting the volume of the audio system, as needed, to make sure that that message is received, but not jarring.

### BRIEF DESCRIPTION OF THE DRAWINGS

The present invention is illustrated with five drawings.

FIG. 1 is an isometric view of an emergency vehicle.

FIG. 2 is an isometric view of a passenger vehicle.

FIG. 3 is an archetypal system architecture for a vehicle entertainment system containing a radio.

FIG. 4 is an archetypal system architecture for a vehicle infotainment system.

FIG. 5 is an intersection representation of an emergency vehicle broadcasting an emergency signal to near-field traffic.

### DETAILED DESCRIPTION

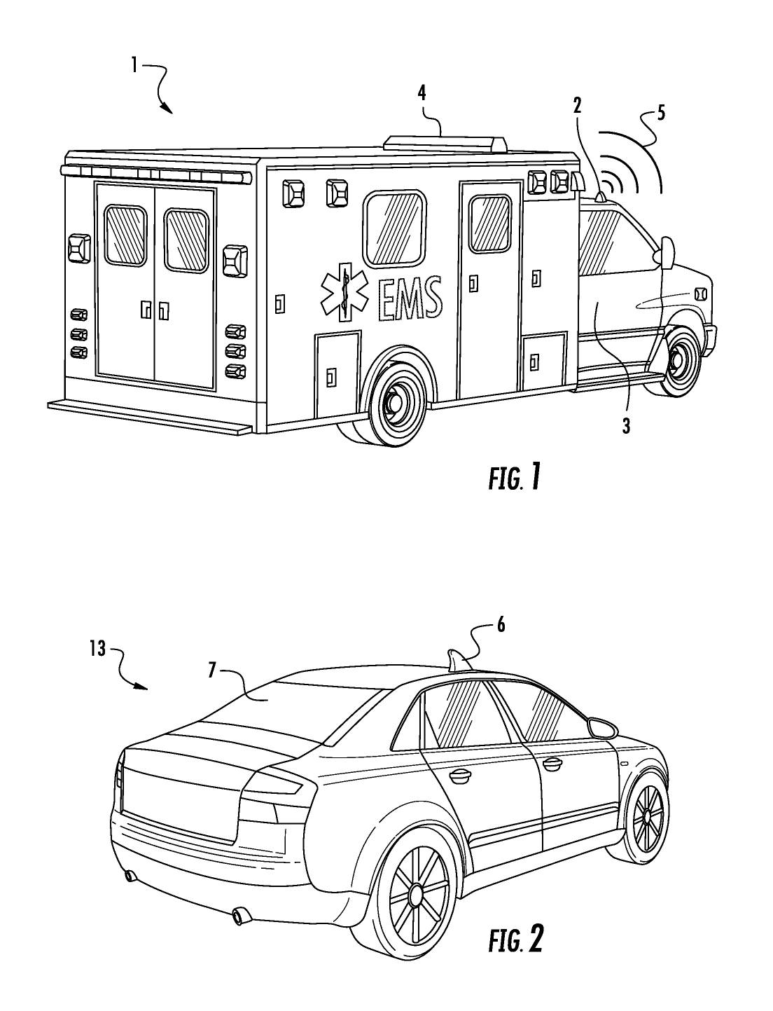

The following descriptions are not meant to limit the invention, but rather to add to the Summary of Invention, and illustrate the general design and implementation of an emergency vehicle alert system using a back-up radio frequency tuner. FIG. 1 shows an isometric view of an emergency vehicle 1 with an emergency light bar 4. The emergency vehicle 1 has a low-power radio frequency transmitter 2 mounted on top of the passenger compartment 3. The low-power radio frequency transmitter 2 emits an emergency message 5 at an emergency message frequency.

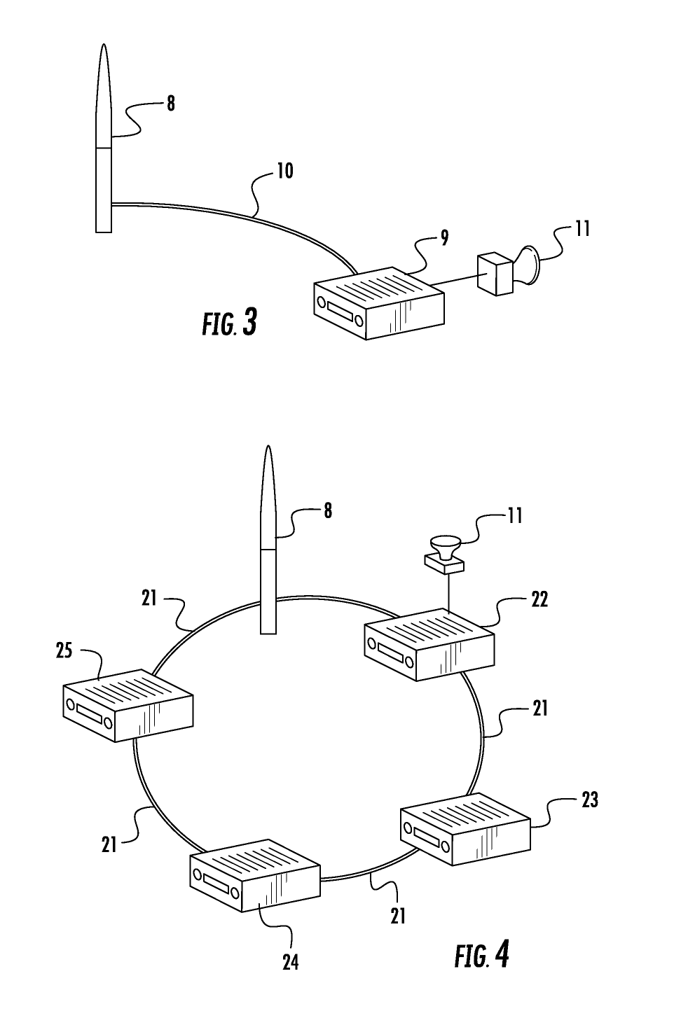

FIG. 2 shows a passenger vehicle 13 with a passenger compartment 7. A radio frequency antennae 6 is attached to the passenger vehicle 13. FIG. 3 shows a simple passenger vehicle 13 entertainment system, containing just the antennae interface 8 a bus connection 10, a radio 9, and a plurality of loudspeakers 11. FIG. 4 shows a more complex infotainment system on a bus ring 21. The infotainment system includes an antennae interface 8, a bus ring 21, a radio tuner/receiver 22, a plurality of loudspeakers 11, and a plurality of other infotainment devices 25, 24, 23. The other infotainment devices 25, 24, 23 could include devices such as a navigation unit; a display unit; a hands-free telephone system; a text-to-speech and speech-to-text system; and, a network gateway (to connect the bus ring 21 to another automotive bus).

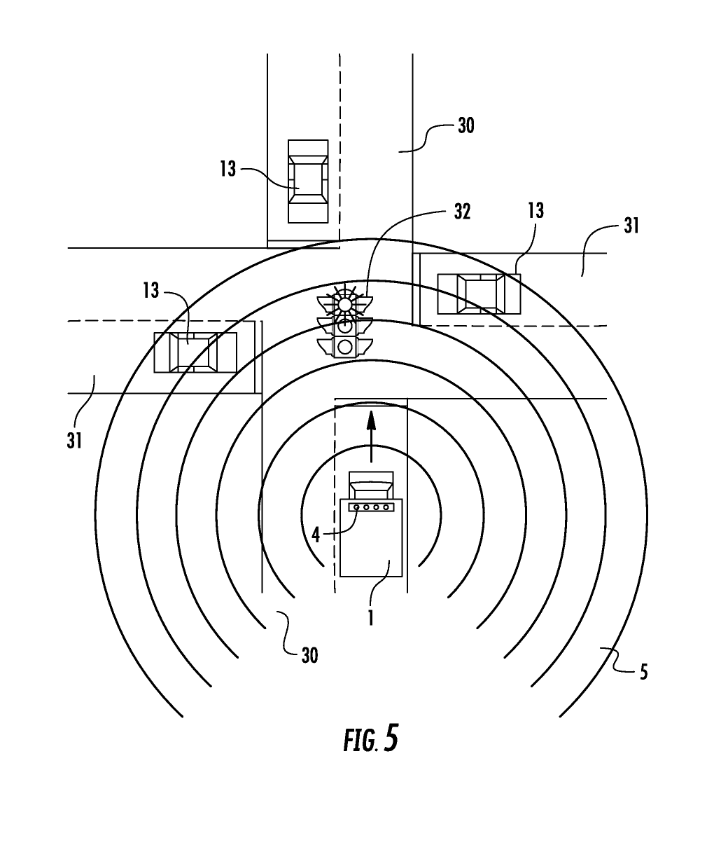

FIG. 5 shows a top view diagram of an intersection. There is an emergency vehicle 1, with emergency lights 4, approaching a traffic light 32 along a first road 30. A plurality of passenger vehicles 13 are in proximity to the intersection, on both the first road 30 and a second road 31. The emergency vehicle 1 is transmitting a low-power radio frequency emergency message 5. The plurality of passenger vehicles 13, enabled with the present invention, receive the emergency message 5 through an antennae 6. The antennae 6 is interconnected with an antennae interface 8, which, in turn, is connected to a bus 21, 10.

The emergency message 5 is presented by the antennae 6 and antennae interface 8, or other similar hardware, to the bus 21, 10, or other similar hard-wired connection. A back-up tuner resident in the radio receiver/tuner 22, 9 periodically scans the emergency message frequency. When the back-up tuner detects an emergency message 5 being transmitted over the emergency message frequency, a software method transmits a system interrupt message, or equivalent, allowing the back-up tuner to take priority of the entertainment/infotainment system. The system interrupt message, or equivalent, causes the entertainment/infotainment system to set the audio output of the system to the tuner receiving the emergency message 5, and the emergency message 5 is played over the loudspeaker system 11 of the passenger vehicle 13.

I claim:

1. An emergency vehicle alert system, broadcasting an emergency message from an emergency vehicle to one or more passenger or light vehicles in near proximity of the emergency vehicle, comprising:
a low-power radio frequency transmitter, mounted in the emergency vehicle, capable of transmitting an emergency message at an emergency frequency;
a plurality of passenger vehicles containing an entertainment or infotainment system comprising, at least, an antenna; a radio with multiple tuners; one or more loudspeakers; and direct, or indirect, connections between the antenna and radio, and between the radio and loudspeakers;
a method for allowing the detection of the emergency message, wherein one or more tuners, each designated a back-up tuner, periodically scans the emergency frequency for the presence of an emergency message;
a method for comparing the level of a received emergency message to a pre-defined threshold level;
a method for transmitting a service interrupt, or equivalent, when the emergency message level exceeds the pre-defined threshold level, to the entertainment or infotainment system, giving the back-up tuner receiving the emergency message control of the system's audio output; and
a switching means for connecting the tuner receiving the emergency message to the loudspeaker(s).

2. The invention in claim 1, wherein the low-power radio frequency transmitter transmits in the FM signal band.

3. The invention in claim 2, wherein the low-power FM transmitter transmits at a power of less than 100 Watts.

4. The invention in claim 2, wherein the low-power FM transmitter transmits at a power of less than 10 Watts.

5. The invention in claim 1, wherein the low-power radio frequency transmitter transmits in the AM signal band.

6. The invention in claim 1, wherein the low-power radio frequency transmitter transmits in another radio frequency band used for, inter alia, audio.

7. The invention in claim 1, wherein the low-power radio frequency transmitter has an effective range of no more than 200 feet or 61 meters.

8. The invention in claim 1, wherein the low-power radio frequency transmitter has an effective range of no more than 3.2 miles or 5 kilometers.

9. The invention in claim 1, wherein the switching means is incorporated as part of the system interrupt, or equivalent.

10. The invention in claim 1, wherein the back-up tuner scans the emergency frequency at least once every second.

11. The invention in claim 1, wherein the back-up tuner scans the emergency frequency at least once every ten (10) seconds.

12. The invention in claim 1, wherein the emergency message gives the location and direction of travel of the emergency vehicle.

13. An emergency vehicle alert method, for broadcasting an emergency message from an emergency vehicle to one or more passenger or light vehicles in near proximity of the emergency vehicle, comprising:
transmitting an emergency message at an emergency frequency from an emergency vehicle using a low-power radio frequency transmitter;
receiving the emergency message in a passenger or light vehicle, using an entertainment or infotainment system comprising, at least, an antenna;
a radio with multiple tuners; one or more loudspeakers; and direct, or indirect, connections between the antenna and radio, and between the radio and loudspeakers;
using one or more tuners, each designated a back-up tuner, to detect the emergency message by periodically scanning the emergency frequency for the presence of an emergency message;
comparing the level of a received emergency message to a pre-defined threshold level;
transmitting a service interrupt, or equivalent, when the emergency message level exceeds the pre-defined threshold level, to the entertainment or infotainment system, giving the back-up tuner receiving the emergency message control of the system's audio output; and
switching the output of the tuner receiving the emergency message to the loudspeaker(s).

14. The invention in claim 1, wherein the low-power radio frequency transmitter transmits in the FM signal band.

15. The invention in claim 2, wherein the low-power FM transmitter transmits at a power of less than 100 Watts.

16. The invention in claim 2, wherein the low-power FM transmitter transmits at a power of less than 10 Watts.

17. The invention in claim 1, wherein the low-power radio frequency transmitter transmits in the AM signal band.

18. The invention in claim 1, wherein the low-power radio frequency transmitter transmits in another radio frequency band used for, inter alia, audio.

19. The invention in claim 1, wherein the low-power radio frequency transmitter has an effective range of no more than 200 feet or 61 meters.

20. The invention in claim 1, wherein the low-power radio frequency transmitter has an effective range of no more than 3.2 miles or 5 kilometers.

21. The invention in claim 1, wherein the switching means is incorporated as part of the system interrupt, or equivalent.

22. The invention in claim 1, wherein the back-up tuner scans the emergency frequency at least once every second.

23. The invention in claim 1, wherein the back-up tuner scans the emergency frequency at least once every ten (10) seconds.

24. The invention in claim 1, wherein the emergency message gives the location and direction of travel of the emergency vehicle.
